(19) United States
(12) Patent Application Publication
(10) Pub. No.: US 2004/0054445 A1
(43) Pub. Date: Mar. 18, 2004

(54) Method for controlling devices in a communications network of an automobile

(76) Inventors: Vasco Vollmer, Holle (DE); Wolfgang Baierl, Remshalden (DE)

Correspondence Address: Striker, Striker & Stenby, 103 East Neck Road, Huntington, NY, 11743, US

(21) Appl. No.: 10/275,831

(22) PCT Filed: Mar. 15, 2001
(86) PCT No.: PCT/DE01/00990

(30) Foreign Application Priority Data
May 9, 2000 (DE) 100-22-423.7

(51) Int. Cl. G06F 17/00

(52) U.S. Cl. 701/1

(57) ABSTRACT

A method for controlling devices in a communications network in a motor vehicle and a device in a communications network in a motor vehicle are proposed, which are used to control newly added devices. To that end, a generic control module and data stored in the device are used to generate a device-specific control component, which can be used to control the device. The device-specific control component can either be added to the generic control module or can be stored independently of the generic control module in the respective device. The generic control module is used in a gateway or a system manager of the communications network. The human-machine interface is adapted by means of the device-specific control component. A bus system, preferably embodied according to IEEE 1394, is used as the technology for the communications network. The essential advantage of the invention is the self-configurability of the communications network and its devices.

### PRIOR ART

The invention is based on method for controlling devices, and a device in a communications network in a motor vehicle, as generically defined by the independent claims.

The use of communications networks in motor vehicles is already known. These communications networks serve to connect controllable devices and sensors. The controllable devices in particular include infotainment devices, such as a car radio, navigation devices, and audio media player devices.

One technology proposed for communications networks in motor vehicles is a serial bus system according to IEEE 1394. In it, the terminal devices are connected to one another by means of a 4 to 6-wire cable or by means of an optical waveguide. End pieces contained in the bus are referred to as leaves, relay nodes are referred to as branches, and the uppermost node is finally referred to as a root. This bus system is self-configuring, i.e. all nodes in the bus system send data via themselves to the other nodes. The bus management can be transferred to one or more nodes. When there are several nodes that are provided for the bus management, a competition is occurs and the winner of this competition takes over the bus management. An operating software runs on the individual nodes, which permits the communications network to be operated.

### ADVANTAGES OF THE INVENTION

The method according to the invention for controlling devices and the device according to the invention in a communications network in a motor vehicle, with the features of the independent claims, have the advantage over the prior art that if needed, a generic control module generates a device-specific control component for a device newly added to the communications network; data stored in the device are taken into account, thus permitting a control and active integration of the new device into the communications network. This process is achieved without having to produce a run time environment. This results in reduced costs. The operating software is thereby distributed as needed to different devices of the communications network in order to assure the function of the device.

The method according to the invention is particularly suited for connection of the devices by means of a radio interface or an infrared interface since new devices are frequently connected by means of such interfaces.

Advantageous improvements of the method for controlling devices, and the device in a communications network in a motor vehicle disclosed in the independent claims are possible by means of the steps taken in the dependent claims.

It is particularly advantageous for the device-specific control component to be used independently of the control module. It is therefore advantageously possible for the control module and the device-specific control component to be stored independently of each other and therefore these components do not necessarily have to be contained in the same device. In this connection, the term “device” refers to a component connected to a bus.

Alternatively, it is advantageous to add the device-specific control component to the generic control module. This enables the generic control module to control the new device. A prerequisite for this is that the generic control module be used to control all of the devices; alternatively, generic control modules can be contained in different system managers or gateways.

It is advantageous for the generic control component to be stored in gateways and is therefore given an overriding function in the central node in the communications network.

It is also advantageous for the device-specific control component to automatically or interactively adapt the human-machine interface in the motor vehicle to the newly added device. As a result, the additional functionality performed by the newly added device advantageously becomes immediately apparent to a user.

It is also advantageous for the communications network to be embodied as a bus system since bus systems in motor vehicles represent an advantageous network technology for connecting various devices to one another and in particular for integrating newly added devices into a communications network. It is particularly advantageous for the bus system to be embodied according to the IEEE 1394 standard since this is a standard for the consumer electronics industry.

It is also advantageous for the data stored in the newly added device to include the functions connected with this device, parameters required for operation, permissible value ranges, the required resolution, and the chronological sequences in the processing of commands. As a result, the operation of the newly added device is defined at a minimal memory cost and the smallest possible data base; these data are used to generate the device-specific control component.

Finally, it is also advantageous that a device, preferably a gateway, is provided, which has the operating system with the generic control module, so that the gateway uses the communications network to call up the data from the other devices connected to the communications network and uses these data to generate the device-specific control component, which can then be used to control the respective additional device.

### DRAWINGS

Exemplary embodiments of the invention are depicted in the drawings and will be explained in detail in the subsequent description.

FIG. 1 depicts the structure of the communications network and

FIG. 2 depicts the method according to the invention in the form of a flow chart.

### DESCRIPTION

Because it is increasingly common for motor vehicles to have communications networks for connecting a wide range of devices to one another, such as car radios, playback devices of sound carriers, navigation devices, and locating devices, it has become necessary to make it easy to install newly added devices.

According to the invention, therefore, the communications network is provided with a generic control module that uses data stored in the device to generate device-specific control components, which make it possible to control these devices. It is then possible to use the control for other applications that make use of these device-specific control components. The applications are either devices with software or also other software programs that run on the device to be controlled.

Distributing the device-specific control components over the individual devices, system managers, or gateways achieves a respectively suitable configuration. An alternative is to add the device-specific control component to the generic control module. The data stored in the device precisely define the possible functions, which can be performed by this device, and indicate parameters, value ranges, resolutions, and chronological sequences required for the operation. These data are therefore particularly used to generate device-specific control components.

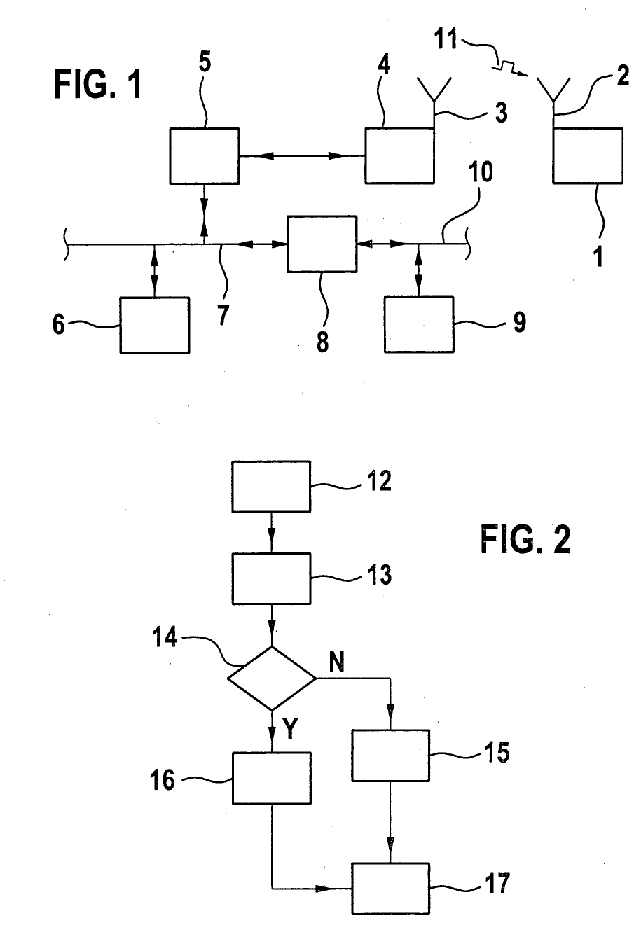

FIG. 1 shows a configuration of a communications network in a motor vehicle. For example, three different network technologies have been used here: a radio connection 11, a bus 7, and an additional bus 10. Gateways represent the interfaces between these different communications network technologies. In particular, gateways prevent an unauthorized access to a communications network.

The radio connection 11 connects a portable computer with its attached antenna 2 to a gateway 4 via its antenna 3. Alternatively, it is also possible to provide an infrared free space transmission here. In this case, the portable computer 1 has an infrared sensor and receiver, which the gateway 4 then also has. Alternatives for the portable computer include a mobile telephone, a personal digital assistant, or a device in another communications network.

The gateway 4 is connected via a data input/output and a line to a first data input/output of a system manager 5. The system manager 5 controls the devices connected to the bus systems 7 and 10. The system manager 5 can be alternatively implemented with the gateway 4 on a computer in the motor vehicle. The system manager 5 is connected to the bus 7 via a second data input/output. The bus 7 is connected to a CD player 6 via a data input/output. The bus 7 is connected to a data input/output of the gateway 8. The gateway 8 is connected to the bus 10 via a data input/output. The bus 10 is connected to a location device 9 via a data input/output.

Alternatively, it is possible to connect other components such as navigation devices, car radios, or minidisk players to the bus systems 7 and 10. The gateways 4 and 8 assure that a controlled and authorized access that is possible in one network technology is also possible in the other network technology. These gateways 4 and 8 prevent unauthorized network accesses. A device connected to the bus systems 7 and 10 has a bus controller, which controls the data communication via the respective bus system.

In FIG. 2, the method according to the invention for controlling devices in a communications network in a motor vehicle is shown in the form of a flow chart. In particular, when new devices are added, the method according to the invention can generate a device-specific control component as needed, which makes it possible to control this newly added device. In this instance, the CD player 6 has just been connected to the bus 7 and should now be controlled by the portable computer 1 and the system manager 5. Since there is no device-specific control component for the CD player 6, this must now be generated.

The fact that a new device, in this case a CD player 6, has been connected to the bus 7 is detected in step 12. This is detected by the system manager 5 on which the generic control module is running. To that end, a device newly connected to the bus 7 sends data that identify it as a new device and log it on. The generic control module is in a position to use data stored in a device to generate the device-specific control component for this device.

In step 13, therefore, the generic control module uses data stored in the CD player 6 to generate the device-specific control component. These data include the functions and commands of the CD player 6; functions can be comprised of a number of commands. In the CD player, these include ejecting the CD, playing the CD, pause, stop, a random playing of different titles, a storing of different titles, and the output of CD text. These functions are thus already stored in the device as are prescribed maintenance schedules and chronological relationships that exist between individual commands of a function. In addition, parameters, value ranges of a resolution, and physical units are stored in the device, by means of which the device-specific control component, i.e. the control component for the CD player 6, is generated. The device-specific data are thus stored in a definite structure in the CD player 6. The commands that execute the functions of the device are stored in a standardized, automatically processable language, which is also known as the Function Description Language (FDL). The parameters, value ranges, and the resolution are also stored in FDL. Additional data regarding processing times and chronological relationships between the commands of a function are described in FDL, for example by means of a flow chart or a time diagram. In step 14, a test is made as to whether the device-specific control component has been added to the generic control module in the system manager 5. If this is not the case, then in step 15, the device-specific control component is stored in the CD player 6, i.e. in the device itself, and can thus be used by various control instances, such as the portable computer 1. To that end, the portable computer 1 contains a software element that can be used to exert control over the device-specific control component. The device-specific control component can also be transferred directly to the portable computer 1 and then used as a software element.

Then in step 17, the portable computer 1 controls the CD player 6. However, if it is determined in step 14 that the device-specific control component should be added to the generic control module in the system manager 5, then this is executed in step 16 so that the device-specific control component is stored in the generic control module in the system manager 5. The system manager 5 also has the device-specific control component for the locating device 9, which has already been generated. In this instance, a manufacturer of the locating device 9 has already generated such a device-specific control component in the locating device 9.

Then in step 17, the CD player 6 is controlled by means of the system manager 5 and the now expanded generic control module is executed. In this case, a software element that differs from the generic control module is rerecorded for the portable computer 1 in order to assure the control. This has security aspects because if the portable computer 1 has use of the generic control module, which has different device-specific control components, it is then possible to control other components. Alternatively, however, this can also be permitted on a case-by-case basis.

The method according to the invention also makes it possible to generate a device-specific control component for a device connected to the communications network via a wireless interface. The wireless interface is either embodied as a radio interface or as an infrared interface. With a radio interface, the device to be connected and the gateway, which receives the data from the device and sends data to it, each have a respective send/receive device and an antenna. With an infrared interface, both the device and the gateway have an infrared transmitter and an infrared receiver; the infrared transmitter can be a laser or light-emitting diode, whereas a photodiode is used for the infrared receiver.

In a motor vehicle, a user has at least one human-machine interface for controlling the existing infotainment components. If a new device is added, with the generation of the device-specific control component, the human-machine interface is then automatically broadened by the functions defined for this new device. For the CD player 6, this means that the functions of the CD player 6 are shown on a display in the motor vehicle, for example in a menu, and can be selected by a user. This occurs, for example, by means of the known soft keys. Such soft keys are freely programmable so that they can be easily adapted to newly added functions.

1. A method for controlling devices, which are connected to a communications network in a motor vehicle, wherein an operating software is provided on a device of the communications network, characterized in that the operating software has a generic control module added to it, that the generic control module and data stored in at least one additional device of the communications network are used to generate a device-specific control component for the at least one additional device, and that the device-specific control component can be used to control the at least one additional device.

2. The method according to claim 1, characterized in that the device-specific control component is used independently of the generic control module.

3. The method according to claim 1, characterized in that the device-specific control component is added to the generic control module.

4. The method according to claim 2 or 3, characterized in that the generic control module is used in a gateway (4, 8) of the communications network.

5. The method according to one of the preceding claims, characterized in that the human-machine interface in the motor vehicle is adapted by means of the device-specific control component.

6. The method according to one of the preceding claims, characterized in that a bus system (7, 10) is used as the communications network.

7. The method according to claim 6, characterized in that an IEEE 1394 bus system is used as the bus system (7, 10).

8. The method according to one of the preceding claims, characterized in that functions, which are comprised of at least one command and are for controlling the additional devices, are stored in an automatically processable language in the at least one additional device, as are parameters, value ranges, resolutions, and chronological relationships.

9. A device in a communications network in a motor vehicle, wherein the device has an operating software, characterized in that the operating software has a generic control module, which can be used to call up data stored in at least one additional device of the communications network and can be used to generate a respective device-specific control component for the at least one additional device, and that the device-specific control component can be used to control the at least one additional device.

10. The device according to claim 9, characterized in that the device, which has the operating software, is a gateway (4, 8).

11. Another device according to claim 9 or 10, characterized in that the at least one additional device has memory containing device-specific data, wherein the data can be called up via the communications network in the motor vehicle, and that the data can be used to generate the device-specific control component.
